(19) United States
(12) Patent Application Publication
(10) Pub. No.: US 2014/0067587 A1
(43) Pub. Date: Mar. 6, 2014

(54) CUSTOMIZED GOGGLE METHODOLOGY

(71) Applicant: Matthew DiLorenzo, Laurel Hollow, NY (US)

(72) Inventor: Matthew DiLorenzo, Laurel Hollow, NY (US)

(21) Appl. No.: 13/599,813

(22) Filed: Aug. 30, 2012

(51) Int. Cl. G06Q 30/06

(52) U.S. Cl. CPC G06Q 30/0621
USPC 705/26.5

(57) ABSTRACT

There is provided a method of customizing a goggle including providing an online retail store configured to offer the customizable goggle for sale. A customizing menu is displayed on the online retail store and includes a plurality of selectable component headings associated with respective ones of the plurality of customizable components. Each component heading is associated with a plurality of underlying component options selectable by a purchaser. The plurality of component options associated with a selected one of the plurality of component headings are displayed, and then the selected components option is incorporated into the goggle displayed on the online retail store. The online retail store display may vary to reflect various selections made by the user. The customized goggle may then be assembled.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates generally to a method of manufacturing and selling products, preferably goggles, and more specifically to a method of allowing a consumer to customize a goggle being offered for sale.

2. Description of the Related Art

Swimming goggles are well known in the art and are worn by swimmers to allow a swimmer to comfortably open his or her eyes while underwater. Each goggle generally includes a frame, a pair of lenses connected to the frame, and a strap for connecting the goggle to the wearer's head. The frame and lenses are configured to form a fluid tight seal around each of the wearer's eyes to keep the wearer's eyes dry while wearing the goggle. The lens is further adapted to provide the user with a range of vision winch allows the user to view the boundaries of his lane, as well as adjacent swimmers during competition.

Although goggles are worn primary for functional reasons (i.e., to allow the swimmer to see underwater), a swimmer's goggle also contributes to the overall look of the swimmer, as it is one of a limited number of articles worn by the swimmer when swimming. Therefore, the look of the swimmer's goggle is oftentimes a reflection of the swimmer's style and personality. For example, goggles that arc bright and bold may reflect a swimmer with an aggressive nature, while goggles made from more conventional colors may reflect a swimmer with a more regimented disposition.

Goggles are readily available in a wide range of colors and styles so as to suit the different styles and personalities of swimmers. Along these lines, the frame, lenses, and strap may be available In several different colors and shapes, and thus, the swimmer may choose the particular color of goggle that is most desirable to that particular swimmer.

One drawback associated with current goggle offerings is that the color scheme defined by the goggle is typically decided by the manufacturer of the goggle. The manufacturer may offer goggles in different color schemes defined or selected by the manufacturer, wherein the swimmer selects the overall color scheme that is most appealing to that swimmer. In this regard, the current goggle offerings do not provide the consumer with an option of assigning various colors or finishes for the plurality of components that comprise the goggle.

Therefore, there is a need in the art for an unproved method of allowing a consumer to customize goggles to suit the particular aesthetic desires and styles of the consumer. Various aspects of the present invention address these particular needs, as will be discussed in more detail below.

### BRIEF SUMMARY

There is provided a method of customizing a goggle which allows a consumer to make several color and/or style selections in relation to the various components comprising the goggle. As such, the appearance and style of the goggle is not entirely dictated by the manufacturer. The goggle customization method provides the consumer with the opportunity and means to specifically tailor the aesthetics of the goggle in accordance with the particular desires and style of the consumer.

The method includes providing an online retail store configured to offer the customizable goggle for sale, wherein the customizable goggle includes a plurality of customizable components. The method further includes displaying the customizable goggle and a customizing menu on the online retail store. The customizing menu includes a plurality of selectable component headings associated with respective ones of the plurality of customizable components. Each component heading is additionally associated with a plurality of underlying component options (i.e., component colors) selectable by a purchaser. The plurality of component options associated with a selected one of the plurality of component headings are displayed as part of the customizing menu. The selected component option is then incorporated into the goggle displayed on the online retail store. The user may navigate through the customizing menu by selecting the various component headings and various component options associated with the selected headings. The display on the online retail store may adapt to the various selections made by the user throughout the customization process. Once the selections are finalized, the goggle may be assembled including the component options selected by the purchaser.

The customizable goggle components may include at least one selected from the group comprising: a frame, a frame lock, a lens, a gasket, a nosebridge, a toggle, a strap, and a strap adjuster. The underlying component options may include selectable colors for at least one customizable component. The underlying component option may include a mirrored finish for at least one customizable component.

The method may include the step of etching the goggle in accordance with purchaser etching instructions.

The method may further include the step of generating a manufacturing signal including all of the component options selected by the purchaser. The method may additionally include the step of communicating the manufacturing signal to a manufacturing facility. The method may further including the step of storing inventory component at the manufacturing facility and combining components to assemble the goggle in response to receipt of the manufacturing signal.

The method may additionally include the step of mailing the assembled goggle to the purchaser.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIGS. 1-15 are exemplary screenshots from an online retail store offering a customized goggle methodology constructed in accordance with an embodiment of the present invention; and

FIG. 16 is a schematic view of an exemplary system incorporating an embodiment of the customized goggle methodology.

Common reference numerals are used throughout the drawings and detailed description to indicate like elements.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to drawings, wherein the showings are for purposes of illustrating a preferred embodiment of the present invention and are not for purposes of limiting the same, there is shown a method of customizing goggles 10 which allows a consumer to make certain selections related to the appearance of the goggle 10 such that the final design of the goggle 10 suits the particular style of the consumer. In particular, the customized goggle methodology provides a goggle 10 having customizable components available in several different styles, colors, finishes etc. which may be chosen by the consumer to create a unique and distinctive goggle 10. In this regard, the color scheme and overall appearance is not entirely determined by the manufacturer; rather, the customized goggle methodology provides each consumer with an opportunity to influence the final appearance of the goggle 10. Although the present invention is disclosed with specific reference to a customized goggle, those skilled in the art will recognize that the same is applicable to other customized products without limitation.

Before describing the particulars of the customized goggle methodology, the following is a brief overview of the various components included in a standard goggle 10. A goggle 10 generally includes several different components, including but not limited to, a frame 12, a lens 14, a gasket 16, a nosebridge 18, toggles 20, a strap 22, and a strap adjuster 24. The frame 12 generally includes a strip of material formed in the shape of two loops to define a pair of openings. When worn by the wearer, the frame 12 is positioned over the wearer's face such that the wearer looks through the openings.

The goggle 10 further includes a pair of lenses 14 coupled to the frame 12 adjacent respective ones of the openings. The frame 12 and lenses 14 are coupled to each other to define a fluid-tight engagement so as to restrict water from passing through the junction of the lenses 14 and the frame 12. The lenses 14 are additionally sized and configured to define a shape that is substantially similar or complimentary to the size of the openings formed in the frame 12. The lenses 14 are preferably formed from a transparent material to allow the wearer to view through the lenses 14.

The goggle 10 additionally includes a pair of gaskets 16 coupled to the frame 12 adjacent the openings and lenses 14. The gaskets 16 are configured to effectively form a fluid-tight seal with the wearer's face when the gaskets 16 are pressed against the wearer during normal usage of the goggle 10. To that end, the gasket 16 is preferably formed from a water-resistant, resilient material, such as rubber. The fluid-tight seal formed between the gaskets 16 and the wearer is designed to create a pair of air pockets around respective ones of the wearer's eyes to keep the eye dry when the user is swimming. Each air pocket is collectively defined by a gasket 16, the frame 12 and a lens 14.

The nosebridge 18 extends between the part of the frame 12 forming the openings around the wearer's eyes, with the nosebridge 18 being configured to extend over the bridge of the wearer's nose when the goggle 10 is worn by the user. The nosebridge 18 may be separate from the frame 12, or alternatively, integrally formed with the frame 12. The outer surface of the nosebridge 18 may also be emblazoned with a word or design, such as the logo of the goggle manufacturer, or the team for which the swimmer competes.

The strap 22 includes a pair of end portions connected to opposing end portions of the frame 12. The strap 22 is preferably formed from an elastomeric material and is expandable to tit around the head of the wearer and subsequently contractable to cinch or constrict around the wearer's head. In the exemplary embodiment, the strap 22 includes a pair of strap members 22a, 22b which enhance the ability of the strap 22 to remain on the wearer's head.

The toggles 20 are coupled to the pair of strap members 22a, 22b to keep the strap members 22a, 22b in close proximity to each other adjacent, the end portions of the frame 12. In this regard, each toggle 20 engages with both strap members 22a, 22b, and includes a pair of apertures through which respective ones of the straps members 22a, 22b extend. The toggles 20 are preferably positioned adjacent the end portions of the strap members 22a, 22b, adjacent the frame 12, although the toggles 20 may be slidable along the strap members 22a, 22b to adjust the position of the toggles 20 therealong.

The strap adjuster 24 is also connected to the strap 22 and is configured to size the strap 22 to the particular size and comfort of she wearer. In this regard, the strap adjuster 24 may shorten or lengthen the strap 22 by sliding along the strap 22. In the exemplary embodiment, the strap 22 includes a single strap adjuster 24 coupled to the uppermost strap member 22a, although it is understood that the lower strap member 22b may also include a strap adjuster 24.

The goggle manufacturer may have the capability of offering the various components in several different styles, colors or finishes. Thus, various aspects of the customized goggle methodology described herein are directed toward providing the consumer/purchaser with a customization tool that allows the consumer to select the desired color(s) of each component. By using the customization tool, the customer is provided with a means of selecting desired component options to construct a unique goggle 10 having an overall look and design that appeals to the consumer.

Although the exemplary customized goggle methodology described herein allows a user to select various goggle models, as well as component colors, it is understood that other embodiments may offer additional selection options to the consumer, for instance, choice of component size, shape, material etc. may also he offered without departing from the spirit and scope of the present invention. It is additionally contemplated that various optional components may be offered in connection with the customized goggle methodology.

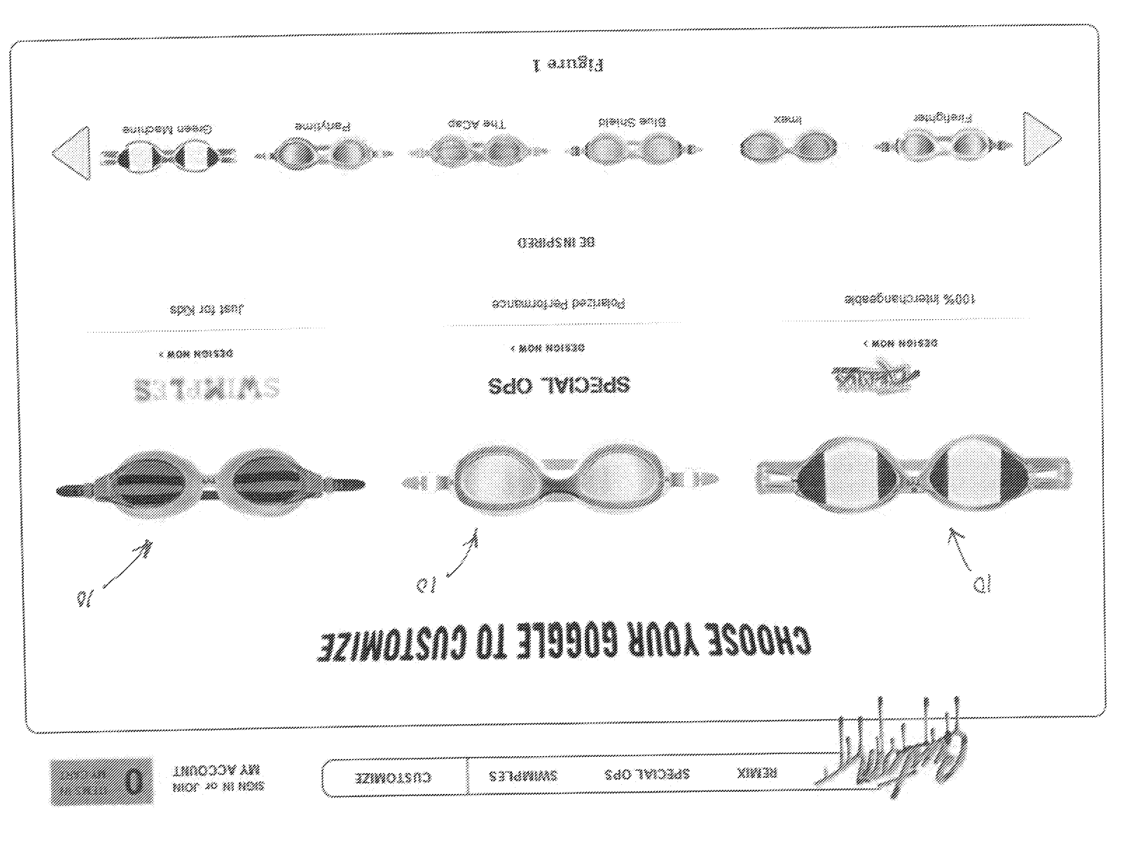

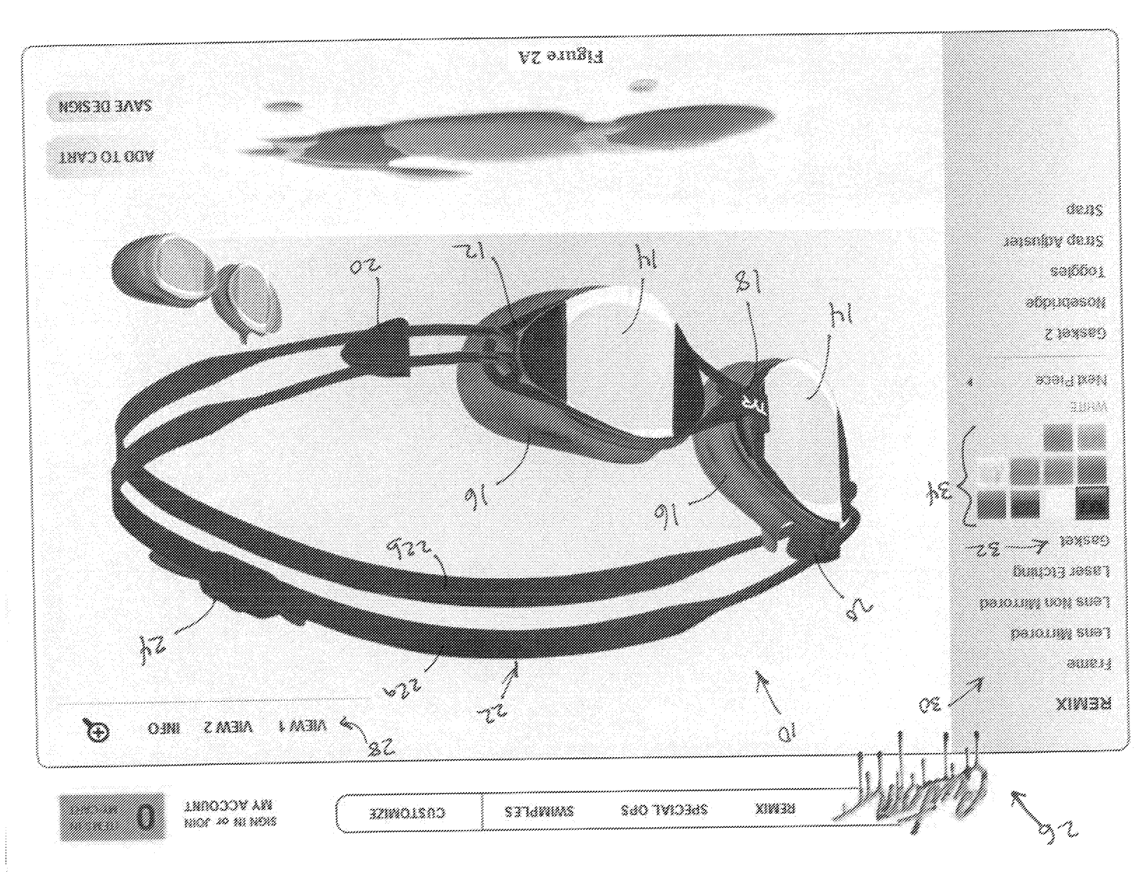

Referring now specifically to FIG. 1, there is shown a screenshot from an online retail store offering goggles 10 for sale. The online retail store may be hosted on a website and accessible via a laptop computer, desktop computer, tablet computer, smart phone, pda, kiosk, or other computing device known by those skilled in the art. The screenshot depicted in FIG. 1 is representative of a website where a purchaser can commence the goggle customization method. As can be seen, the page depicts several different models of goggles 10 which the purchaser may select. The exemplary models shown in FIG. 1 are the REMIX, SPECIAL OPS, and SWIMPLES. The different models may represent one or more differences in the size and shape of the various components which make up the goggles 10. The webpage may include several pictures of the different goggles 10, wherein each picture is a representative of a different goggle model.

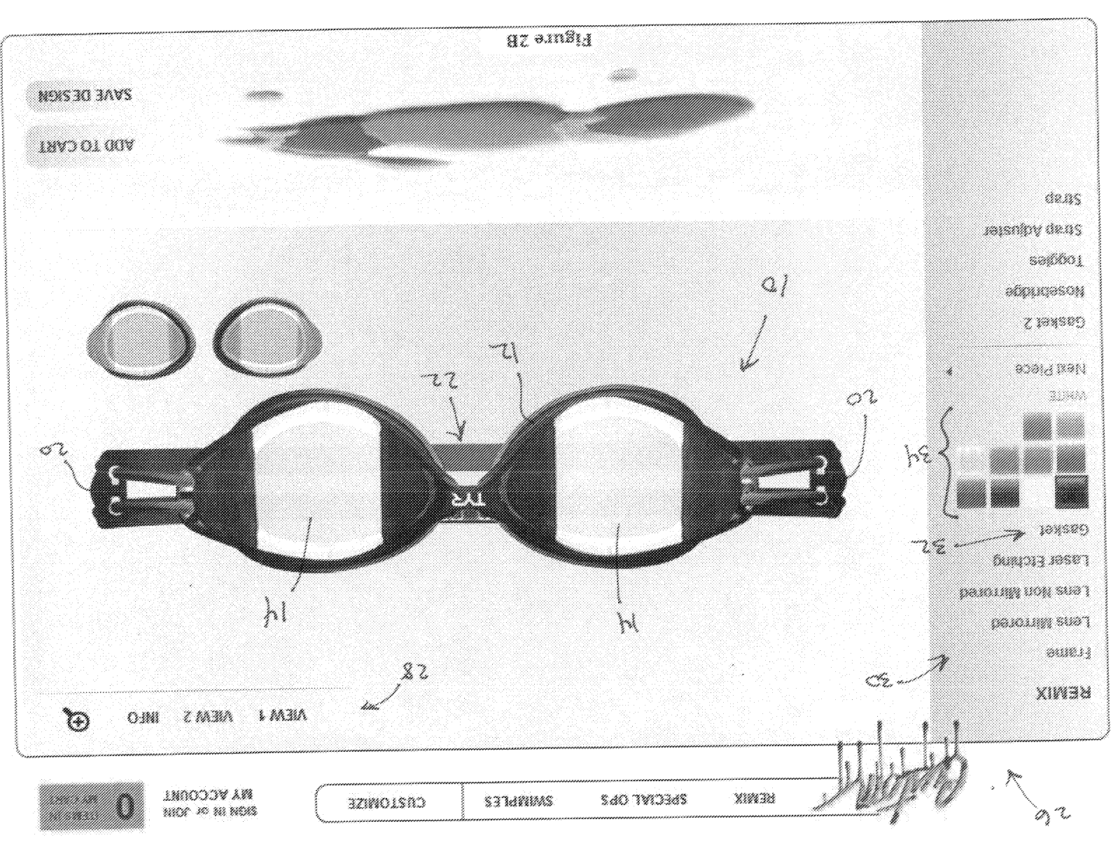

The pictures may be selectable by the purchaser in order to proceed with customizing the selected model. The selection may be made via conventional web-navigation techniques, such as placing a cursor over the desired model and clicking a mouse. After selecting the model, the purchaser may be transferred to a customization tool 26 (see FIG. 2A) for the selected goggle model.

Referring now to FIG. 2A, there is shown a screen shot of a customization tool 26 for a REMIX model goggle 10. When the purchaser selects the REMIX goggle 10 on the screen depicted in FIG. 1, the purchaser is directed to the screen shown in FIG. 2. The screen in FIG. 2A includes a picture of the goggle 10 in a “standard” configuration (i.e., before customization of that model). The screen additionally includes a viewing toolbar 28 with VIEW 1, VIEW 2, INFO, and zoom buttons. The VIEW 1 button is selected in FIG. 2A and shows an upper perspective view of the goggle 10. If the purchaser selects the VIEW 2 button, a front view of the goggle 10 is shown, as depicted in FIG. 2B. The INFO button, when selected, may display a description of the particular model selected, as well as the customizable features of that model. Furthermore, the zoom button (represented by the magnifying glass with the “+”) is selectable to depict an enlarged view of the goggle 10.

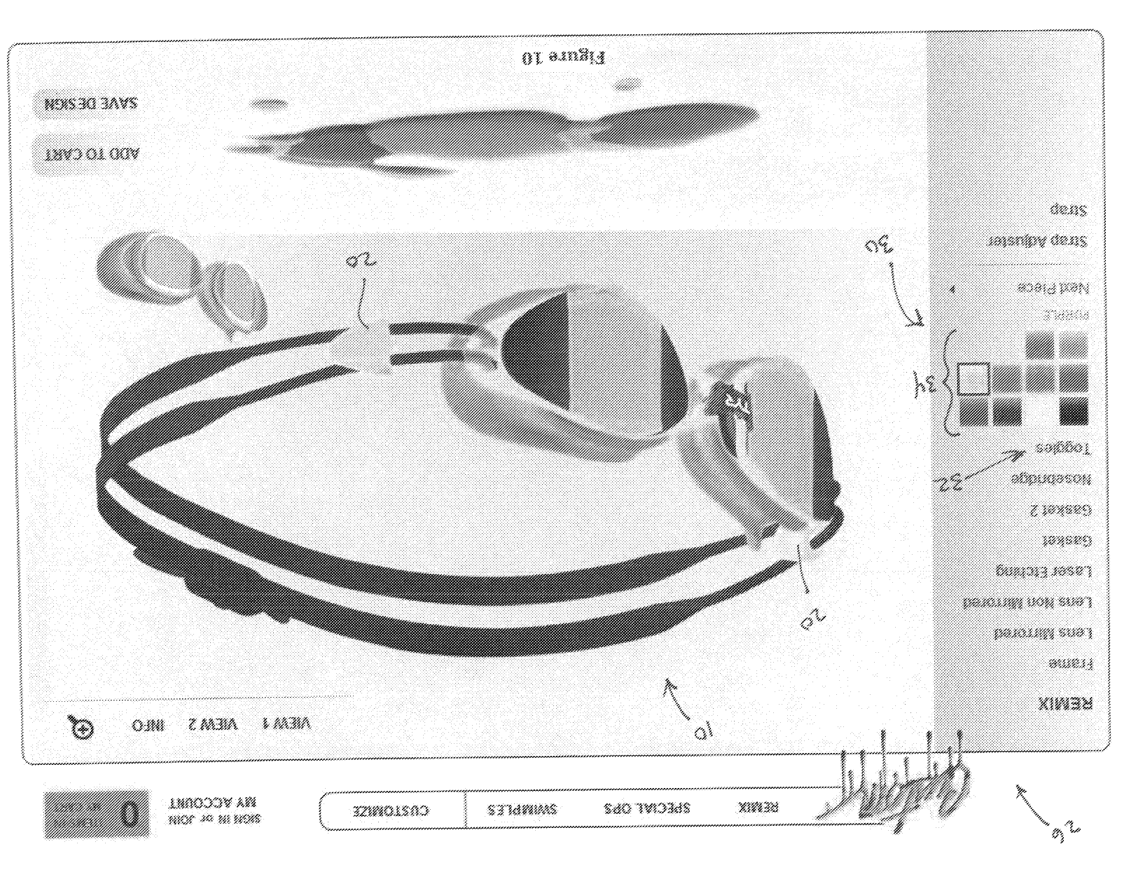

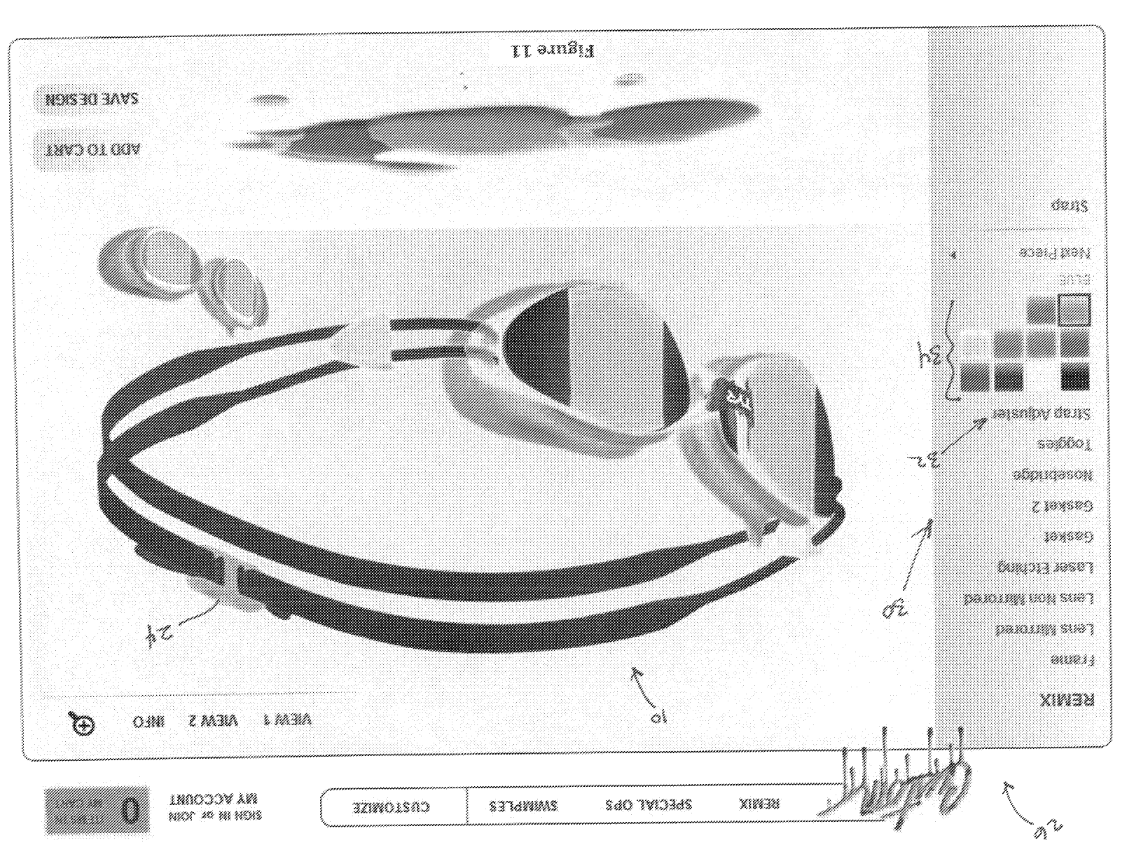

On one side of the screen in FIGS. 2A-13, there is displayed a customizing toolbar 30 which may be used by the purchaser to customize the various components of the goggles 10. The customizing menu/toolbar 30 lists the various components which are customizable, with each component having a selectable heading 32 listing the component (i.e., Frame, Lens Mirrored, etc.). Each heading 32 is associated with underlying component options 34 selectable by the consumer. In the exemplary embodiment, the underlying component options 34 relate to the various colors selectable by the purchaser, although other options such as component shape, size, etc. may also be listed as component options.

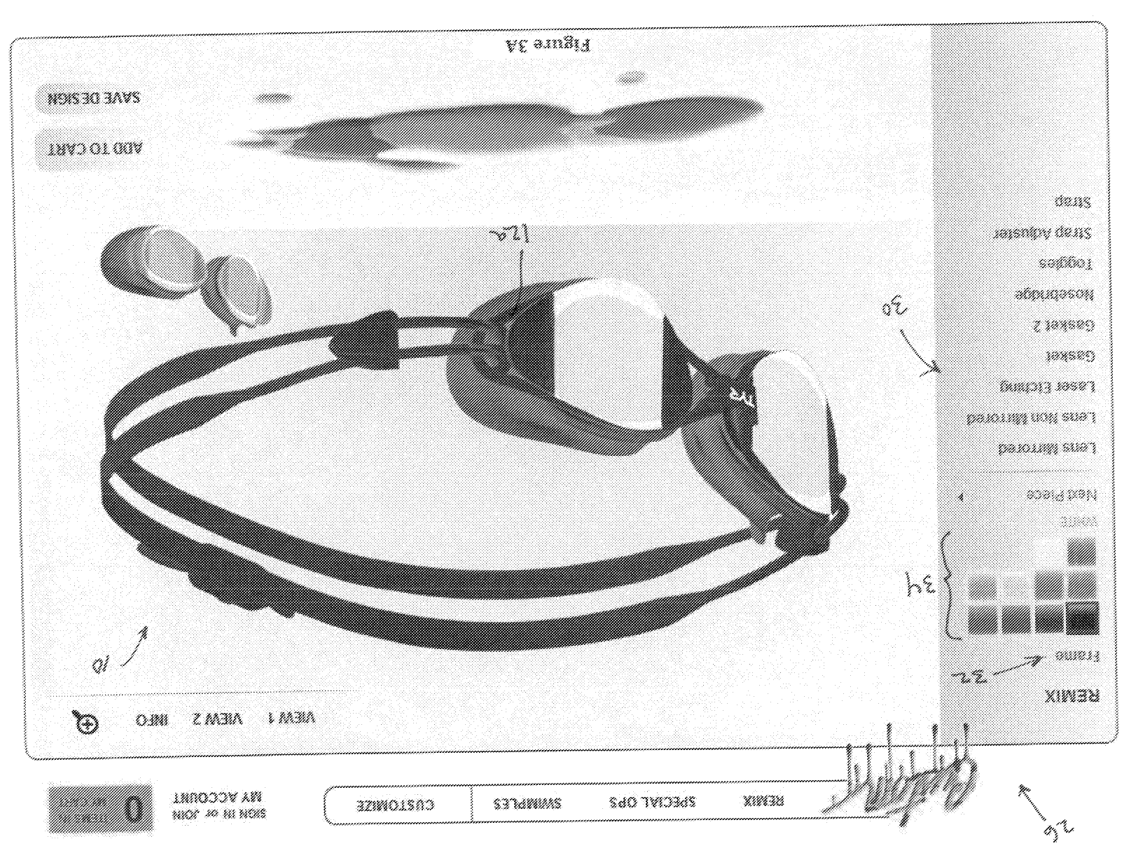

Turning now specifically to FIG. 3A, the “Frame” heading 32 on the customizing toolbar 30 has been selected, which causes the underlying color options 34 for the frame 12 to be displayed. In the exemplary embodiment depicted in FIG. 3A, the purchaser is provided with ten (10) options 34 for the frame color, with each option being depicted by a box filled in with that color. When one of the boxes is selected, the frame color displayed on the goggle 10 changes to the selected color. This aspect of the invention is depicted in FIGS. 3A and 3B. In FIG. 3A, a first color is highlighted, and thus, the frame 12a depicted in FIG. 3A is shown in the first color. In FIG. 3B, a second color has been selected/highlighted, and thus, the frame 12b in FIG. 3B is depicted in the second color. As such, the purchaser may select one color, and then another, with the color of the frame 12 changing as the purchaser makes a new selection. In this regard, the purchaser may consider several different colors before moving on to the next customizable feature.

When the purchaser has settled on a frame color, the user may select the “Next Piece” button 36 (see FIG. 3B) to navigate to the next component heading 32 on the customizing toolbar 30. Alternatively, the user may directly select the heading 32 associated with any one of the other components. In other words, the user is not required to navigate through the customizing toolbar 30 in a top-down approach. The user may skip from one component to the next in any order desired by the user.

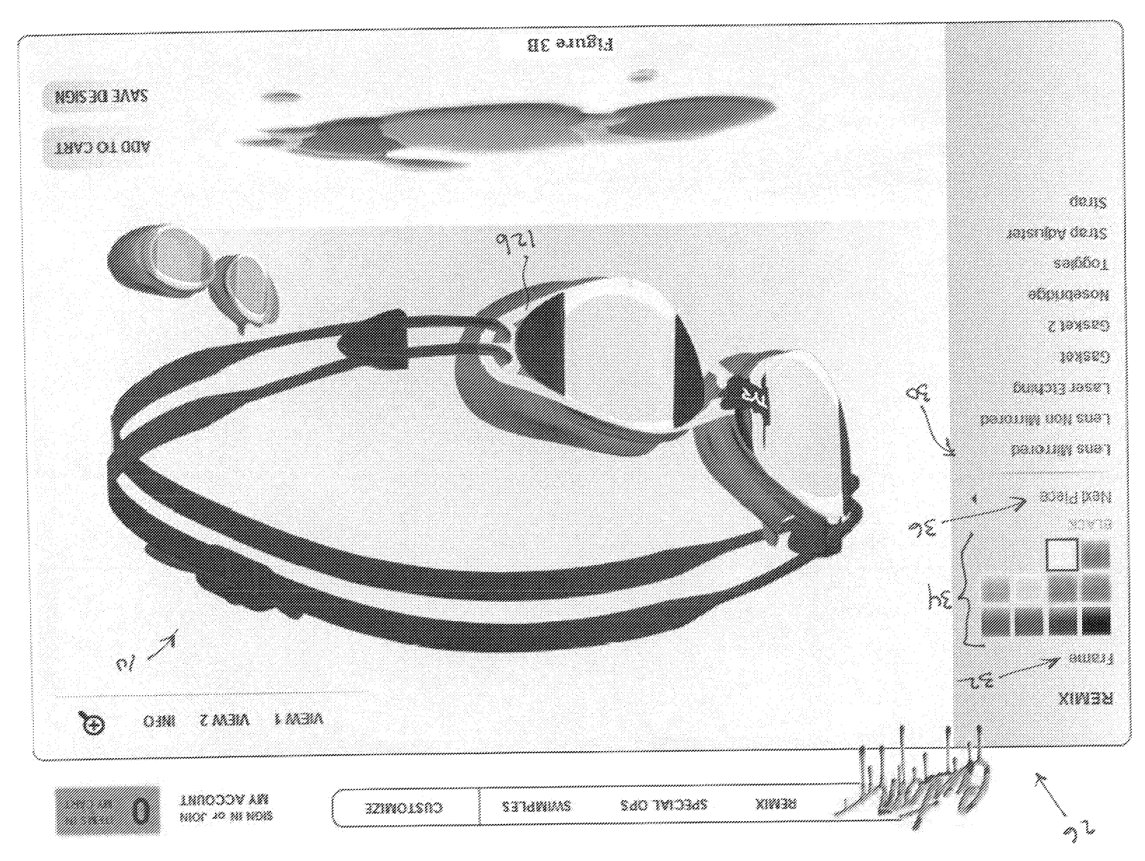

Referring now specifically to FIG. 4, there is shown several different finishes for the goggle lenses 14. Along these lines, the lenses 14 may have a mirrored finish in several different colors (i.e., silver mirror, purple mirror, blue mirror, red mirror, etc.). The lenses 14 may also be offered in a clear finish, or other styles, colors, finishes known by those skilled in the art. As with the frame color discussed above, a user may select various lens colors/finishes for consideration before making a final decision.

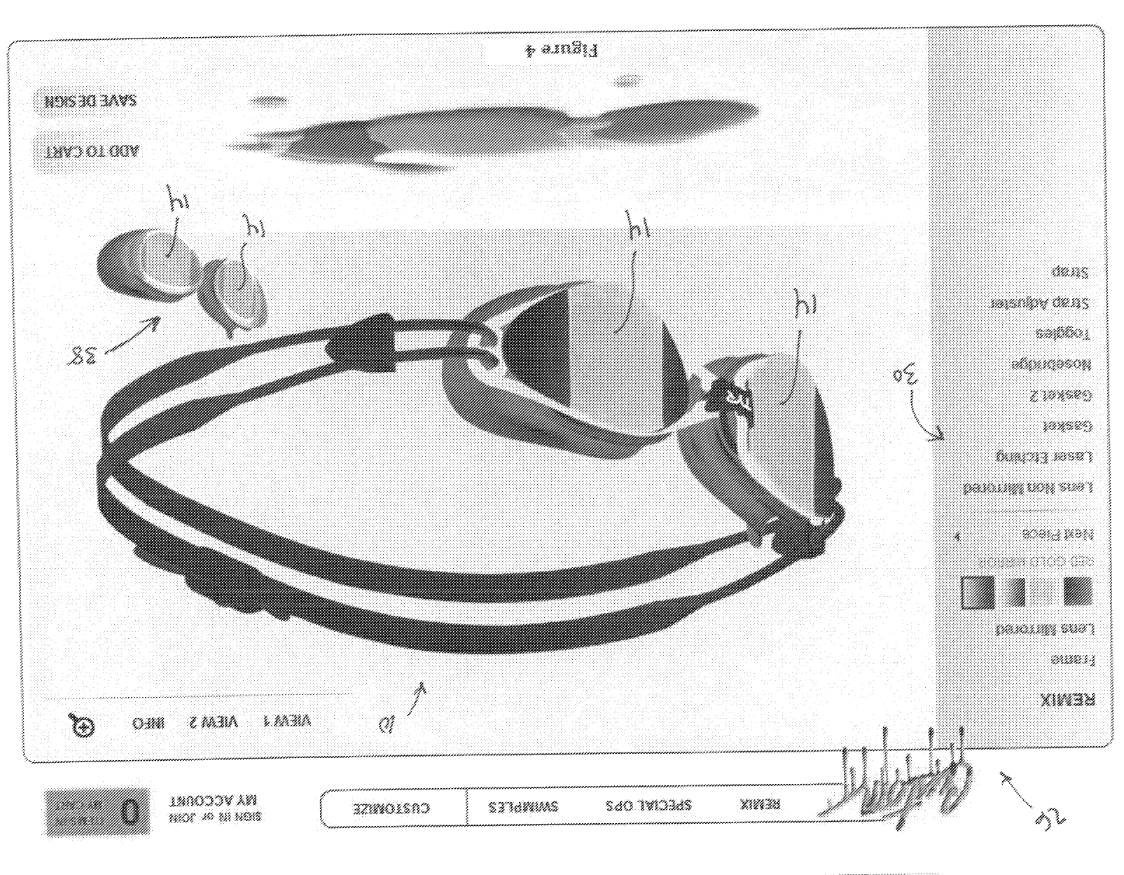

According to one aspect of the present invention, when the customer purchases the goggle 10, the customer may be provided with a pair of interchangeable lens-frame-gasket assemblies, wherein the primary distinction between the assemblies is the color scheme defined by the consumer. The consumer may select a first color scheme for the first assembly and a second color scheme for the second assembly. With regard to the lenses 14 included in the assemblies, the customer may select a mirrored lens finish for one assembly (see FIG. 4), and a non-mirrored lens finish for the second assembly (see FIG. 5). The frame 12 and/or the gasket 16 may also be assigned different colors in the lens-frame-gasket assemblies. The user may selectively interchange or swap-out the assemblies based on the weather conditions, lighting conditions, etc. as desired by the user. The website may depict the second or auxiliary lens-frame-gasket assembly 38 in addition to the goggle 10 including the first or primary lens-frame-gasket assembly.

It is understood that providing the customer with a pair of lens-frame-gasket assemblies, as described above, is a preferred option, but is not required. In other words, there may be other embodiments which simply provide the customer with a single lens-frame-gasket assembly for each goggle purchase.

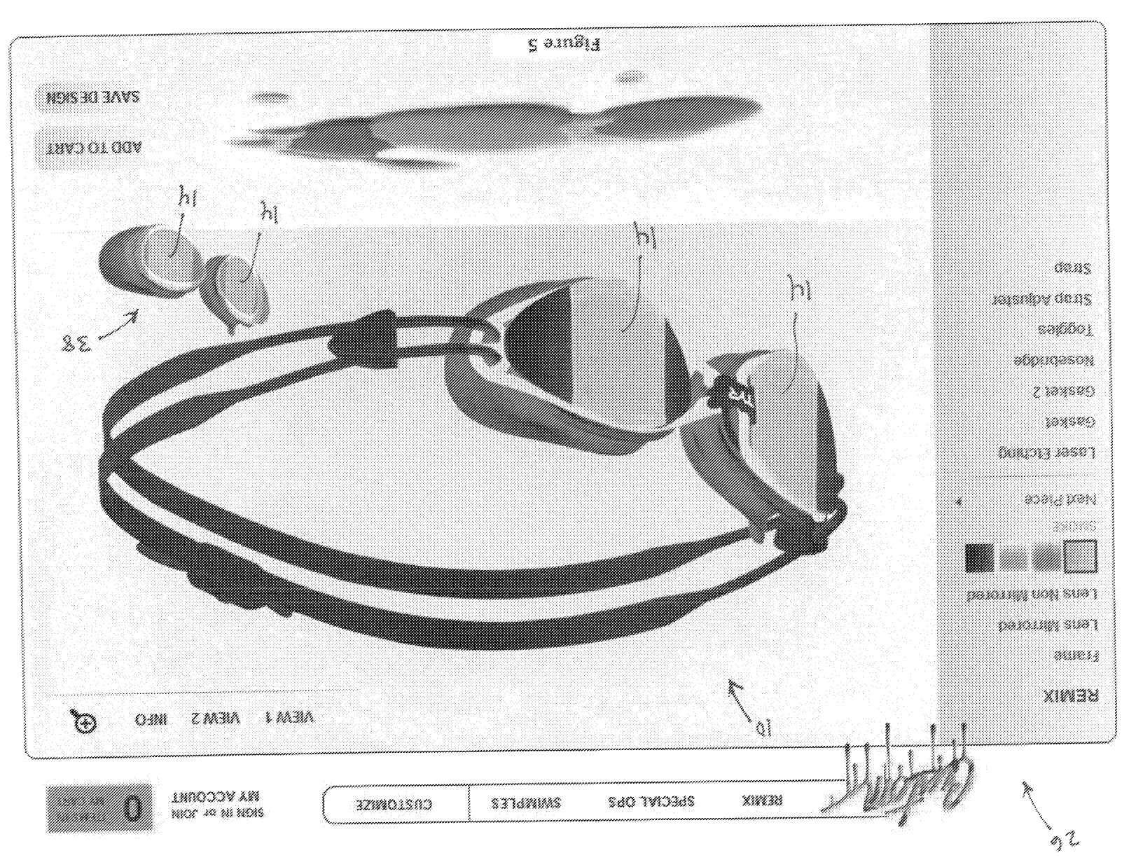

Referring now specifically to FIG. 6, the customer may be provided with the option of having customized etching performed on the goggle 10. The etching is preferably done on one or both of the lenses 14, although the etching may be done on any part of the goggle 10 without departing from the spirit and scope of the present invention. When the etching is performed on the lens 14, it is preferably formed via laser etching, and the word, design, phrase, etc. is formed adjacent the peripheral edge of the lens 14.

The customizing toolbar 30 includes an entry field 40 wherein the customer may enter the name, word, phrase or other customized entry. The toolbar 30 may also allow the user to select one or more font options (i.e., font type, underline, bold, etc.) for the etching formed on the goggle 10.

Although the foregoing describes an optional etching feature, it is contemplated that other embodiments may include printing or other means of transferring the name, word, etc. onto the goggle 10.

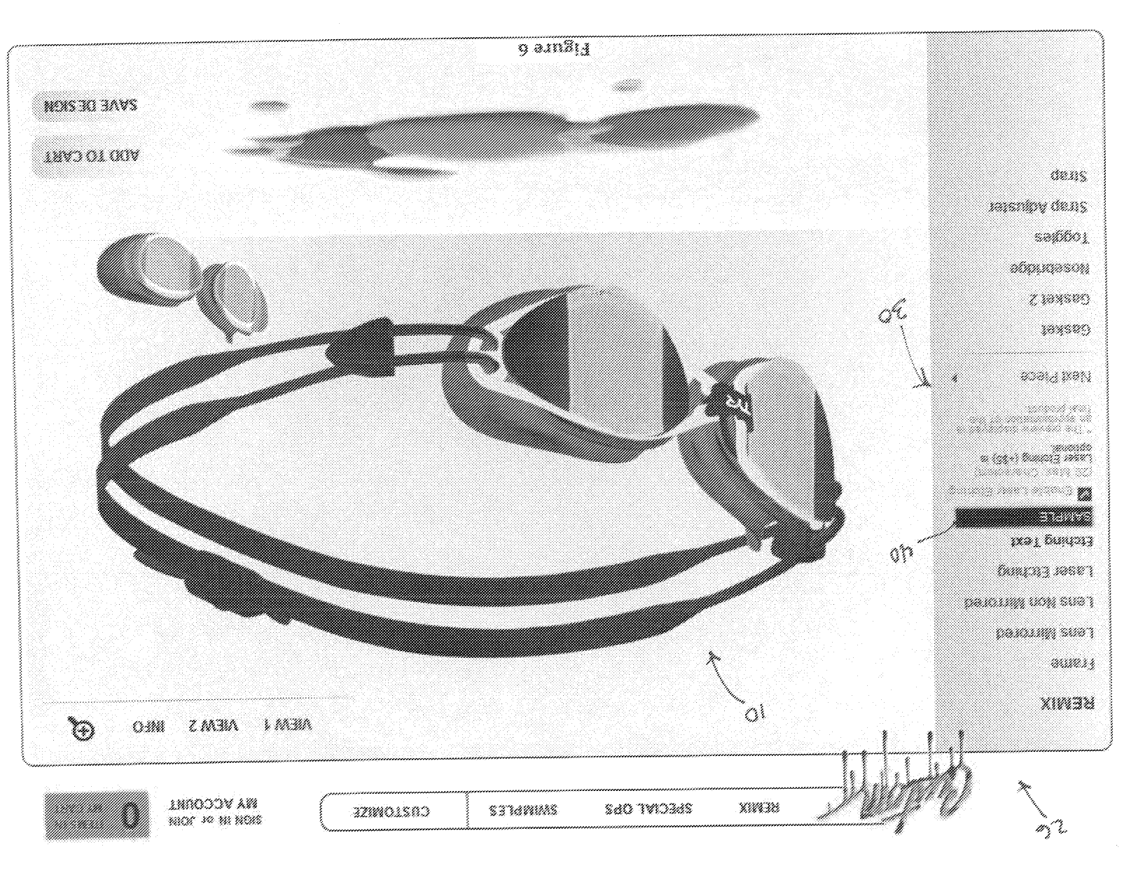

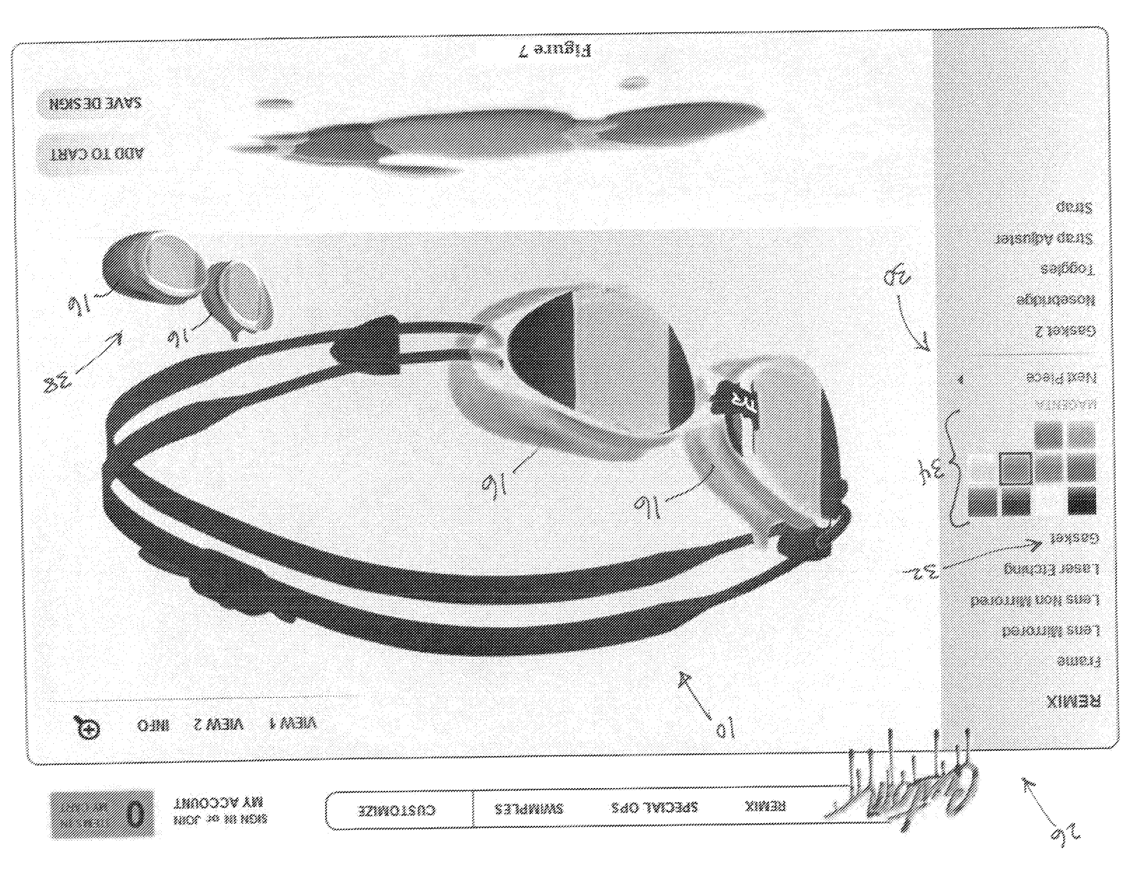

Referring now to FIGS. 7 and 8, there is shown an option for selecting the color of the gasket 16. FIG. 7 shows the selection of the gasket color for the first lens-frame-gasket assembly, while FIG. 8 shows the selection of the gasket color (associated with the Gasket 2 heading 32) for the second lens-frame-gasket assembly 38. The color selection for the gasket(s) is similar to the color selection of the frame and lens described above.

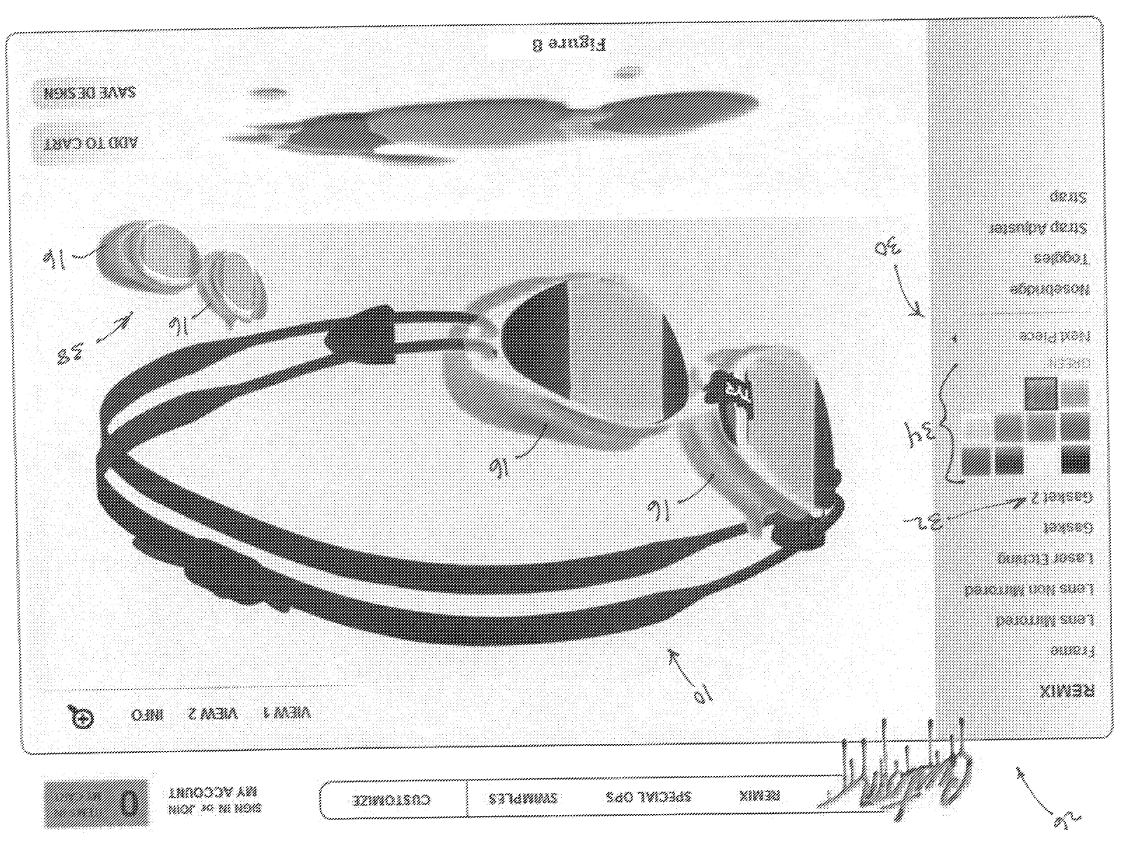

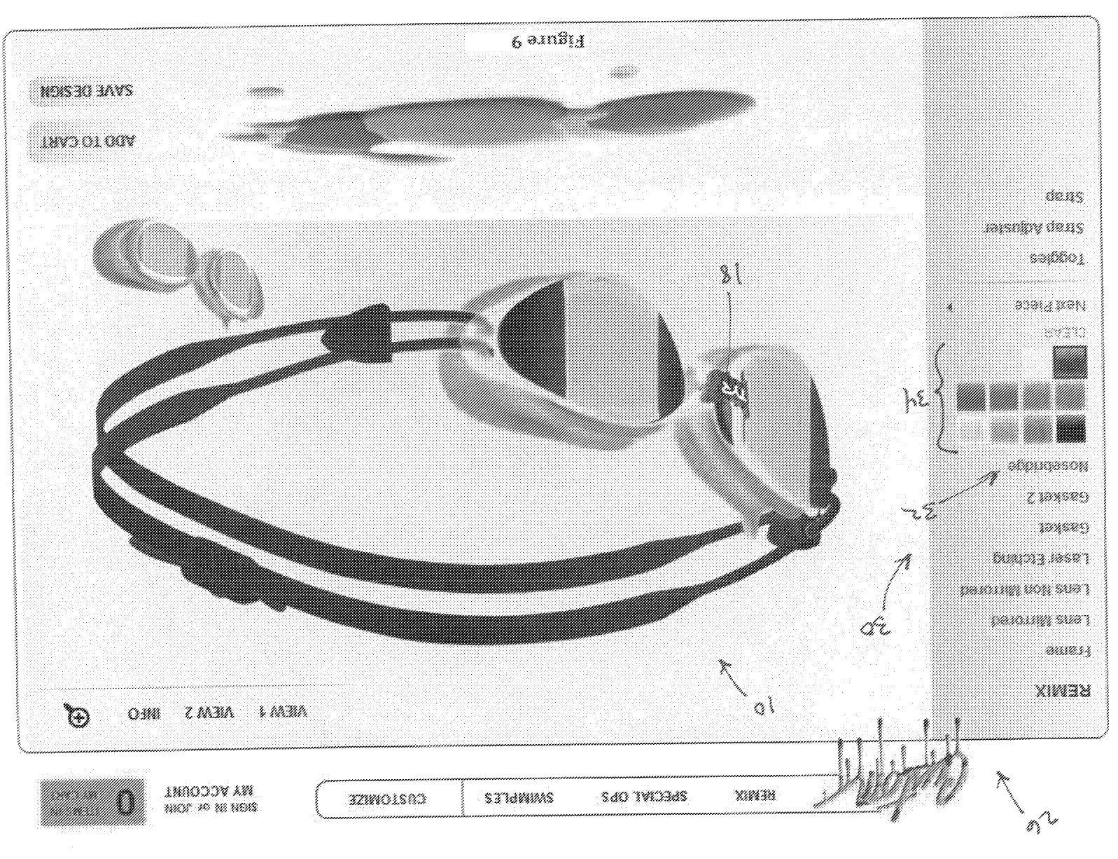

Color selection for the nosebridge 18, toggles 20, strap adjuster 24, and strap 22 is depicted in FIGS. 9-12, and is similar to the color selection described above, and thus, selection of the options related to those components will not be described in detail herein.

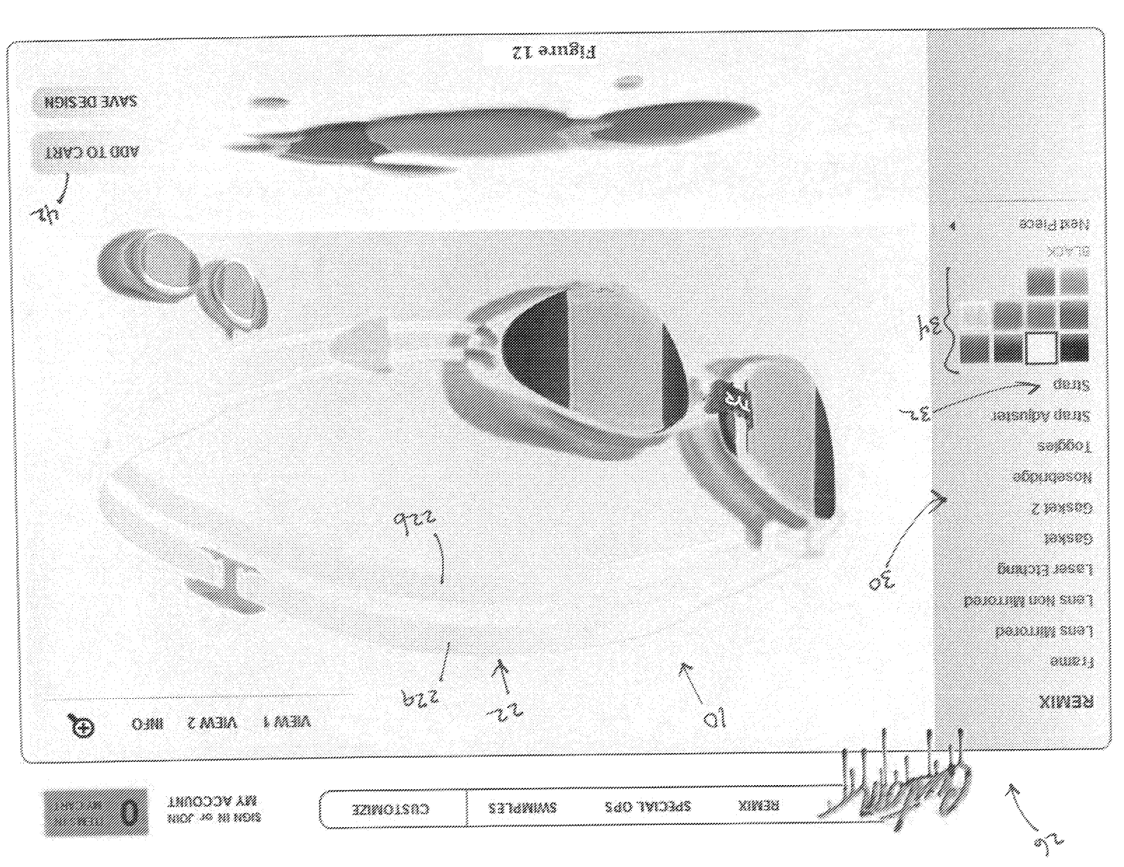

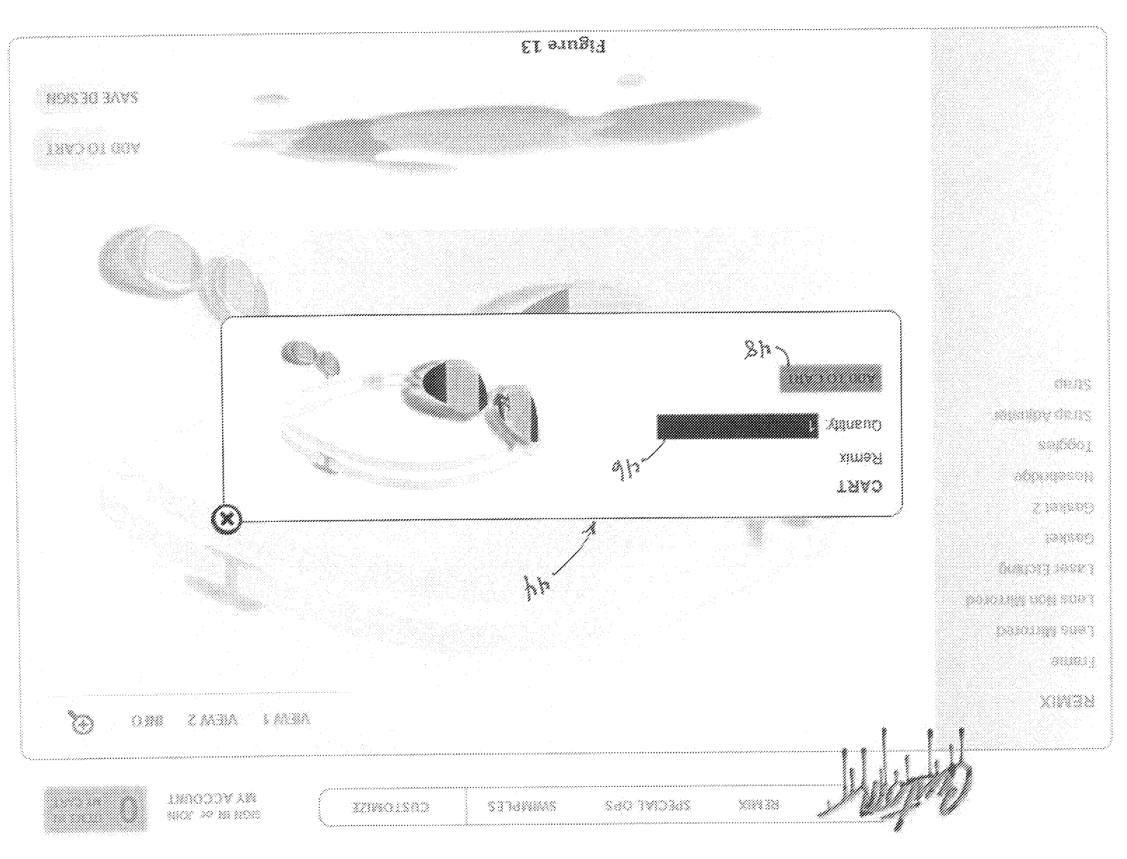

After the customer has customized or selected all of the customizable components of the goggle 10, the user proceeds toward finalizing the order. This is done by selecting the ADD TO CART button 42 (see FIG. 12), which causes the customization system to temporarily save all of the customizing options selected by the user. An optional SAVE DESIGN button may additionally be provided for the user. A quantity-selection screen 44 is then displayed, as shown in FIG. 13, to allow the user to select the number or quantity of goggles 10 for purchase. Once the correct quantity is entered into the quantity field 46, the user selects the ADD TO CART button 48 in the quantity-selection screen 44 to proceed.

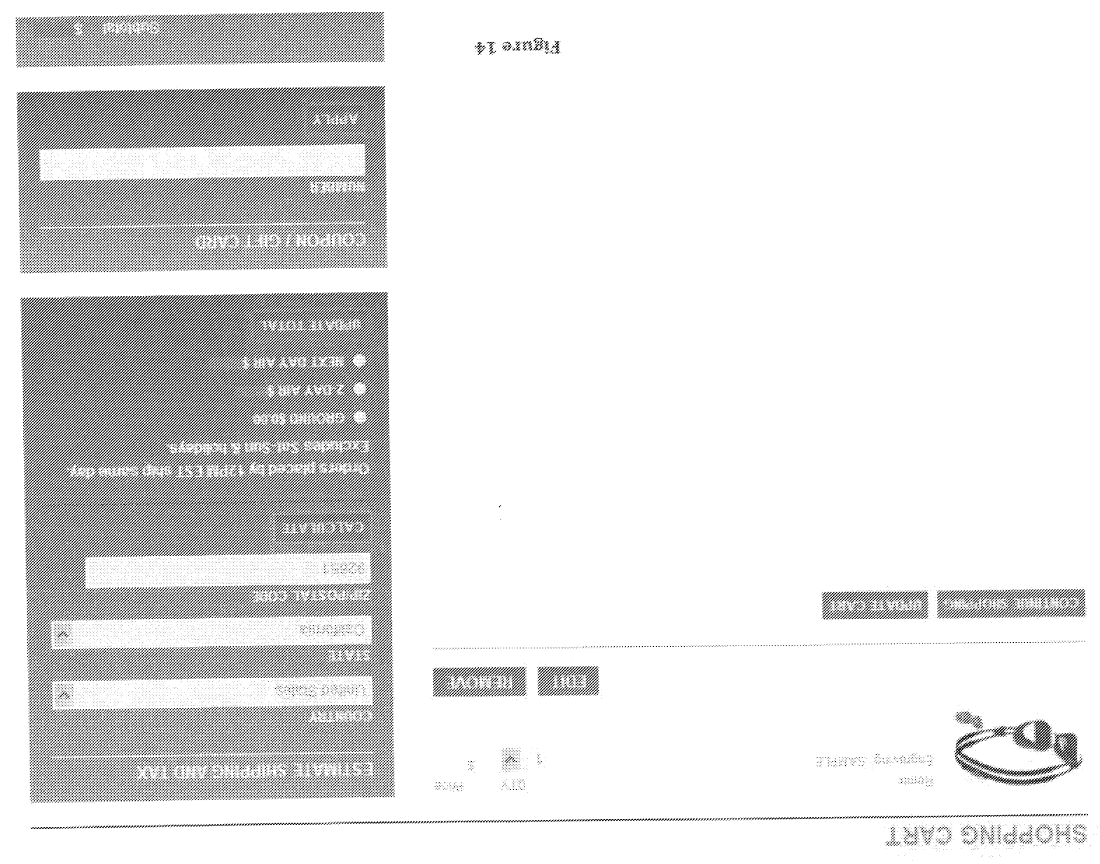

A SHOPPING CART screen (see FIG. 14) is depicted after the user selects the ADD TO CART button 48 in the quantity-selection screen 44. In the SHOPPING CART screen, the user may select a shipping preference, modify the quantity of goggles 10 for purchase, or enter a coupon/gift card. A subtotal may also be depicted in the SHOPPING CART screen to provide the user with a total cost prior to finalizing the purchase.

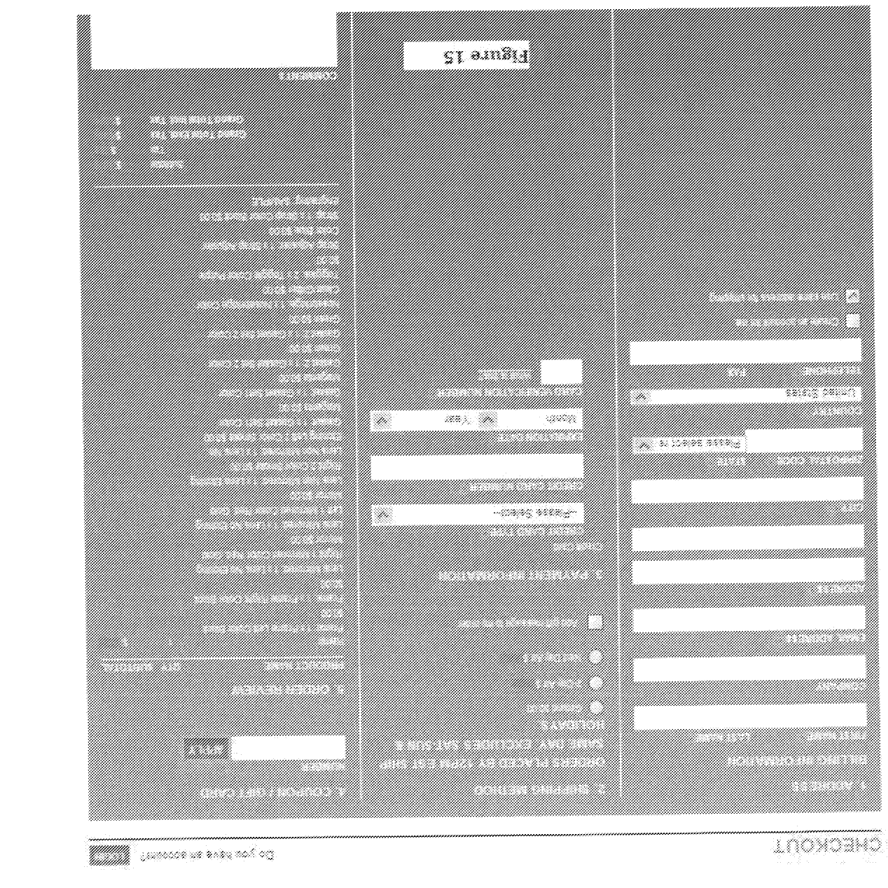

After all of the information is entered, in the SHOPPING CART screen, the customer is directed to a CHECKOUT screen (see FIG. 15) wherein the final details may be entered to complete the purchase. Along these lines, the customer may be prompted to enter the billing address, shipping address, payment information, etc. Once all of the information is entered and verified by the user, the order may be completed. For instance, the user may select a PLACE ORDER and/or PURCHASE button to complete the transaction.

The foregoing describes the customer side of making the various selections for customizing the goggle 10 and proceeding through the purchase thereof. Attention will now be directed toward the manufacturing side, wherein the user selections are received and implemented into the final product (i.e., the customized goggle 10).

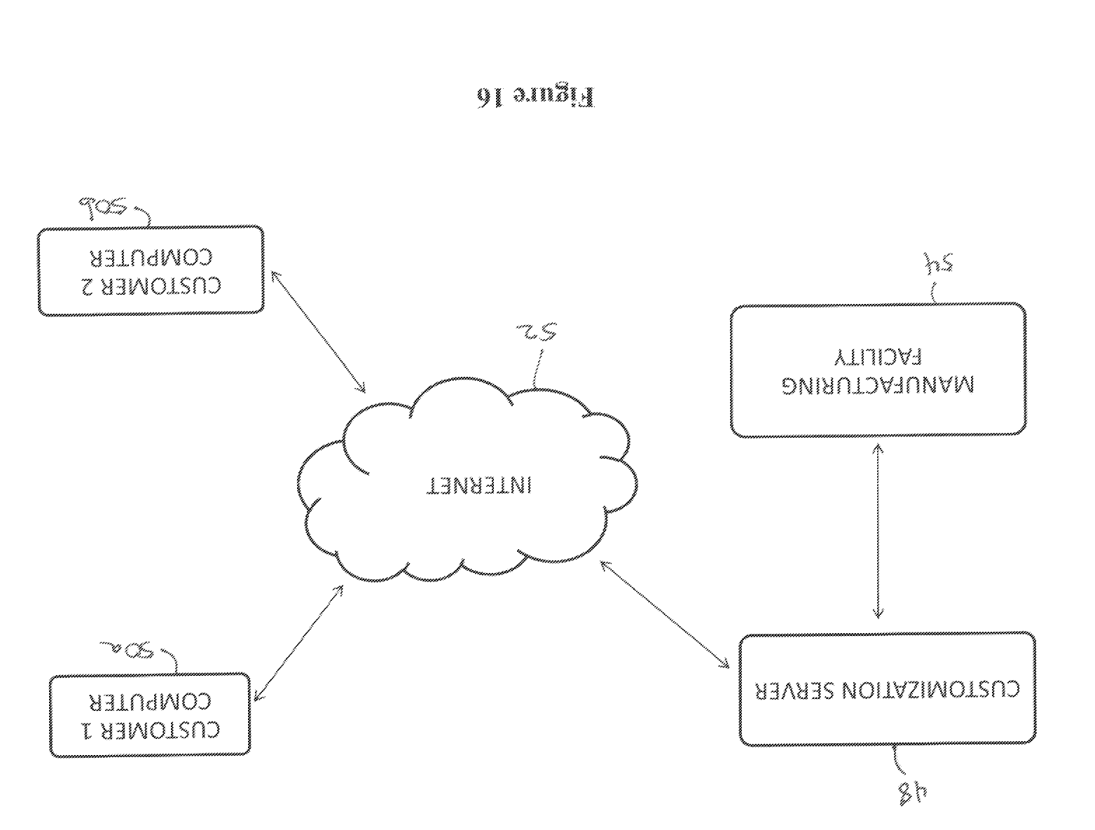

According to one embodiment, the system level architecture is depicted in FIG. 16, and includes a customization server 48 which is in communication with one or more customer computers 50a, 50b via the Internet 52, as well as a manufacturing facility 54. The goggle customization process may be initiated when a customer computer 50a, 50b establishes a connection with the customization server 48 (i.e., when the customer navigates to the goggle customization website). When the connection is established, the customization server 48 may store information that is unique to that customer computer 50a, 50b. such as the IP address or the customer username associated with that computer (which, may be assigned during a registration process).

The customization server 48 is operative to manage the customization process. In this regard, it may be configured to load a website with webpages corresponding to the customization process. The customization server 48 may include a database of images of the various customizable components and options which are selectable by the user. The customization server 48 may further be configured to generate and communicate signals to the customer computer 50a, 50b as the consumer customizes the goggle 10.

Initially, the customization server 48 may communicate a signal corresponding to the screen shown in FIG. 1. When the user visits that initial screen, the user may enter/select the goggle 10 to customize and communicate that information to the customization server. The entry of the consumer information may be as simple as a mouse click over the desired style/model of goggle 10.

The consumer information entered by the customer is communicated from the customer computer 50a, 50b and is received at the customization server 48. The customization server 48 is configured to receive the consumer information and generate a responsive signal for display on the customer computer 50a, 50b. For instance, once the customer makes a goggle selection, the customization server 48 is configured to generate a signal corresponding to the screen shown in FIG. 2A. In other words, the signal generated by the customization server 48 includes a display of the selected goggle 10, as well as the customization toolbar 26. It should be noted that the customization toolbar 26 may be varied depending on the style/model of goggle 10 selected by the consumer. Thus, certain models of goggles 10 may have more customizable options than other models of goggles 10, and the customization server 48 may be able to identity the customizable options associated with the selected style/model of goggle 10 and generate the appropriate customization toolbar 26.

As the user makes selections during the customization process, the computer 50a, 50b generates signals corresponding to those selections, which are then communicated to the customization server 48. The customization server 48 processes that information and sends a responsive signal back to the customer computer 50a, 50b. As noted above, the consumer input may relate to the selection of a component, a component color finish, or the name or phrase for etching.

The consumer input may further relate to the completion of the customization process. Along these lines, when the customization is finalized, a completion signal is communicated to the customization server. The completion signal may include all of the customized elements selected by the user, as well as user identification information (i.e., IP address, username, billing info., etc.).

When the completion signal is received by the customization server 48, a manufacturing signal is communicated from the customization server 48 to the manufacturing facility 54. The manufacturing signal corresponds to the customized goggle 10 created by the consumer, and includes all of the selection of style, color, finish, etching, etc. made by the consumer. The manufacturing facility 54 is configured to receive the manufacturing signal and assemble the customized goggle 10 including all of the features selected by the consumer. In this regard, the manufacturing facility 54 may include an inventory of the goggle components in the various colors, styles and finishes offered on the customization website, and when the manufacturing signal is received, the specific components included in the customized goggle may be collected and assembled. The customized goggles 10 may be packaged and shipped directly to the customer once the assembly is complete.

The above-described goggle customization method allows a goggle manufacturer to meet the specific demands of the consumer and provide the consumer with a significant, amount of flexibility for selecting/creating a goggle that conforms with their particular aesthetic taste. As such, the method provides the consumer with an opportunity to influence the final look of the goggle 10, while at the same time preserving the overall integrity of the product.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of customizing a goggle for sale, the method comprising the steps of:
a) providing an online retail store configured to offer a customizable goggle for sale, the customizable goggle having a plurality of customizable components;
b) displaying the customizable goggle on the online retail store;
c) displaying a customizing menu on the online retail store, the customizing menu having a plurality of selectable component headings associated with respective ones of the plurality of customizable components, each component heading being associated with a plurality of underlying component options selectable by a purchaser;
d) displaying the plurality of underlying component options associated with a selected one of the plurality of component headings;
e) incorporating the selected component option, into the goggle displayed on the online retail store;
f) repeating step d) in response to selection of a respective one of the selectable component headings;
g) repeating step d) in response to selecting an underlying component option; and
h) assembling the goggle including the component options selected by the purchaser.

2. The method recited in claim 1, wherein the customizable components include at least one selected from the group comprising: a frame, a lens, a gasket, a nosebridge, a toggle, a strap, and a strap adjuster.

3. The method recited in claim 1, wherein the underlying component options include selectable colors for at least one customizable component.

4. The method recited in claim 1, wherein the underlying component options include a mirrored finish for at least one customizable component.

5. The method recited in claim 1, further comprising the step of etching the goggle in accordance with purchaser etching instructions.

6. The method recited in claim 1, further comprising the step of mailing the assembled goggle to the purchaser.

7. The method recited in claim 1, further comprising the step of generating a manufacturing signal including all of the component options selected by the purchaser.

8. The method recited in claim 7, further comprising the step of communicating the manufacturing signal to a manufacturing facility.

9. The method recited in claim 8, further comprising the step of storing inventory component at the manufacturing facility and combining components to assemble the goggle in response to receipt of the manufacturing signal.

10. A method of customizing goggles for sale, the method comprising the steps of:
a) providing an online retail store configured to offer customizable goggle for sale, the customizable goggle having a plurality of customizable components;
b) displaying the customizable goggle on the online retail store;
c) displaying a customizing menu on the online retail store, the customizing menu having a plurality of selectable component headings associated with respective ones of the plurality of customizable components, each component heading being associated with a plurality of underlying component options selectable by a purchaser;
d) displaying the plurality of underlying component options associated with a selected one of the plurality of component headings; and
e) incorporating the selected component options into the goggle displayed on the online retail store.

11. The method recited in claim 10, wherein the customizable components include at a frame and a lens.

12. The method recited in claim 10, wherein the underlying component options include selectable colors for at least one customizable component.

13. The method recited in claim 10, wherein the underlying component options include a mirrored finish for at least one customizable component.

14. The method recited in claim 10, further comprising the step of etching the eyewear in accordance with purchaser etching instructions.

15. The method recited in claim 10, further comprising the step of mailing the assembled eyewear to the purchaser.

16. The method recited in claim 10, further comprising the step of generating a manufacturing signal including all of the component options selected by the purchaser.

17. The method recited in claim 16, further comprising die step of communicating the manufacturing signal to a manufacturing facility.

18. The method recited in claim 17, further comprising the step of storing inventory component at the manufacturing facility and combining components to assemble the eyewear in response to receipt of the manufacturing signal.

19. A method of customizing a goggle for sale, the method comprising the steps of:
a) providing an online retail store configured to offer a customizable goggle for sale, the customizable goggle having a plurality of customizable components;
b) displaying the customizable goggle on the online retail store;
c) displaying a customizing menu on the online retail store, the customizing menu having a plurality of selectable component headings associated with respective ones of the plurality of customizable components, each component, heading being associated with a plurality of underlying component options selectable by a purchaser;
d) displaying the plurality of underlying component options associated with a selected one of the plurality of component headings;
e) incorporating the selected component option into the goggle displayed on the online retail store;
f) repeating step d) in response to selection of a respective one of the selectable component headings; and
g) repeating step d) in response to selecting an underlying component option.

20. The method recited in claim 19, further comprising the step of generating a manufacturing signal including all of the component options selected by the purchaser.
